(19) United States
(12) Patent Application Publication
(10) Pub. No.: US 2016/0081323 A1
(43) Pub. Date: Mar. 24, 2016

(54) VIBRATING BIRD DETERRENT

(71) Applicant: John E. Hudson, Gainesville, FL (US)

(72) Inventor: John E. Hudson, Gainesville, FL (US)

(21) Appl. No.: 14/693,295

(22) Filed: Apr. 22, 2015

Related U.S. Application Data
(60) Provisional application No. 62/052,258, filed on Sep. 18, 2014.

(51) Int. Cl. A01M 29/22; A01K 39/01

(52) U.S. Cl. CPC A01M 29/22; A01K 39/0113

(57) ABSTRACT

A bird deterrent is provided. The bird deterrent includes a case, such as a water-resistant case. The case includes an outer wall forming an internal housing to contain internal components of the bird deterrent. The present invention further includes a power supply to supply power. A vibrating tip is electrically connected to the power supply and the wireless receiver via electrical wiring. A remote transmitter is operable to send a signal to the wireless receiver. When the wireless receiver receives the signal, the vibrating tip produces a vibration.

### CROSS-REFERENCE TO RELATED APPLICATION

This application claims the benefit of priority of U.S. provisional application No. 62/052,258, filed Sep. 18, 2014, the contents of which are herein incorporated by reference.

### BACKGROUND OF THE INVENTION

The present invention relates to bird feeders and, more particularly, to a bird deterrent attachable to various types and shapes of bird feeder.

Bird feeders are devices placed outdoors to supply bird food to birds. Most bird feeders supply seeds or bird food. Bird feeders often are used for bird watching. Currently, bird feeders attract all sorts of birds, even birds that may be undesirable to the bird feeder owner. For example, bully birds, such as crows and grackles, dominate the bird feeders and prevent other birds from feeding. Some feeder owners want to feed only small song birds, and some want to restrict the type of bird even further. Current methods of deterring undesirable birds may include shocking the birds or producing noises mocking a predator. Many bird watchers consider shocking a bird to be inhumane, and producing predator noises scares away other desirable birds.

As can be seen, there is a need for an improved device for deterring certain birds from eating from a bird feeder.

### SUMMARY OF THE INVENTION

In one aspect of the present invention, a bird deterrent comprises: a case comprising an outer wall forming an internal housing; a wireless receiver within the internal housing of the case; a power supply; a vibrating tip electrically connected to the power supply and the wireless receiver via electrical wiring; and a remote transmitter operable to send a signal to the wireless receiver, wherein when the wireless receiver receives the signal, the vibrating tip produces a vibration.

In another aspect of the present invention, a bird deterrent comprises: a case comprising an outer wall forming an internal housing; a wireless receiver within the internal housing of the case; a power supply; a vibrating tip electrically connected to the power supply and the wireless receiver via electrical wiring, wherein the vibrating tip and a portion of the electrical wiring are outside of the housing; and a remote transmitter operable to send a signal to the wireless receiver, wherein when the wireless receiver receives the signal, the vibrating tip produces a vibration.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention, shown in use;

FIG. 2 is a perspective view of an embodiment of the present invention;

FIG. 3 is a schematic view of an embodiment of the present invention; and

FIG. 4 is a perspective view of the present invention illustrating the activation of the vibrating tip by the transmitter.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention may include a battery or low voltage powered, radio frequency activated, low volume nonthreatening audible, physical movement, and vibration creating device that scares birds on bird feeders making them fly away. The present invention emits sounds that are quiet enough not to affect the entire area around or near the feeder. At the same time the visual element comes from movement of a physical object near the bird, as opposed to a flashing light. The vibration also causes tactile stimulation. The stimulation of a combination of visual, audible and tactile senses caused by the vibration scares the undesirable bird away.

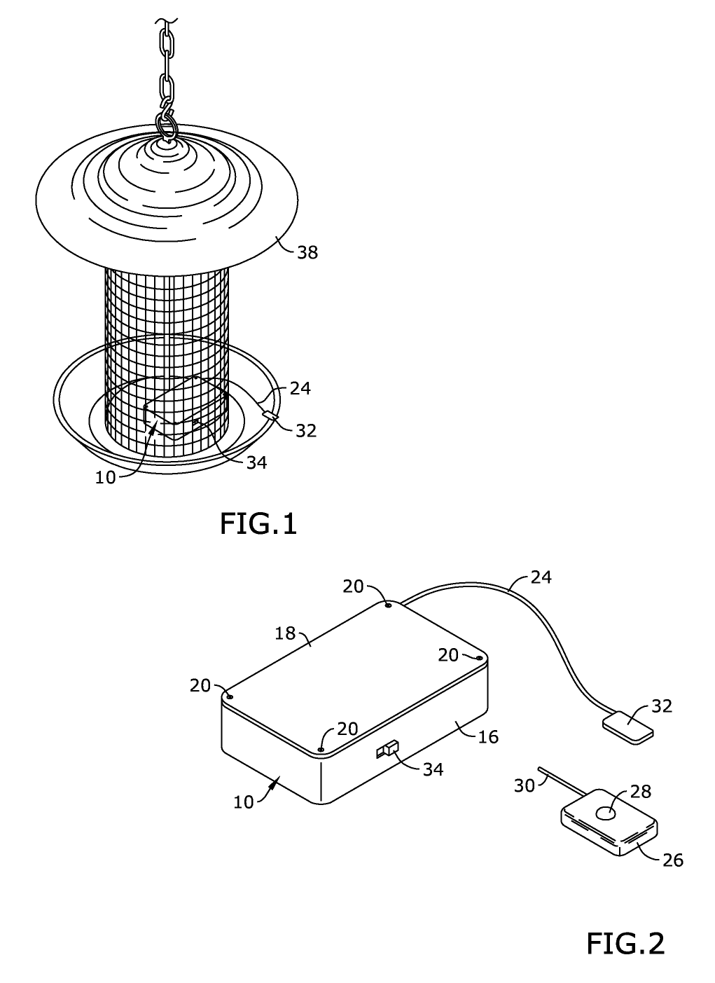

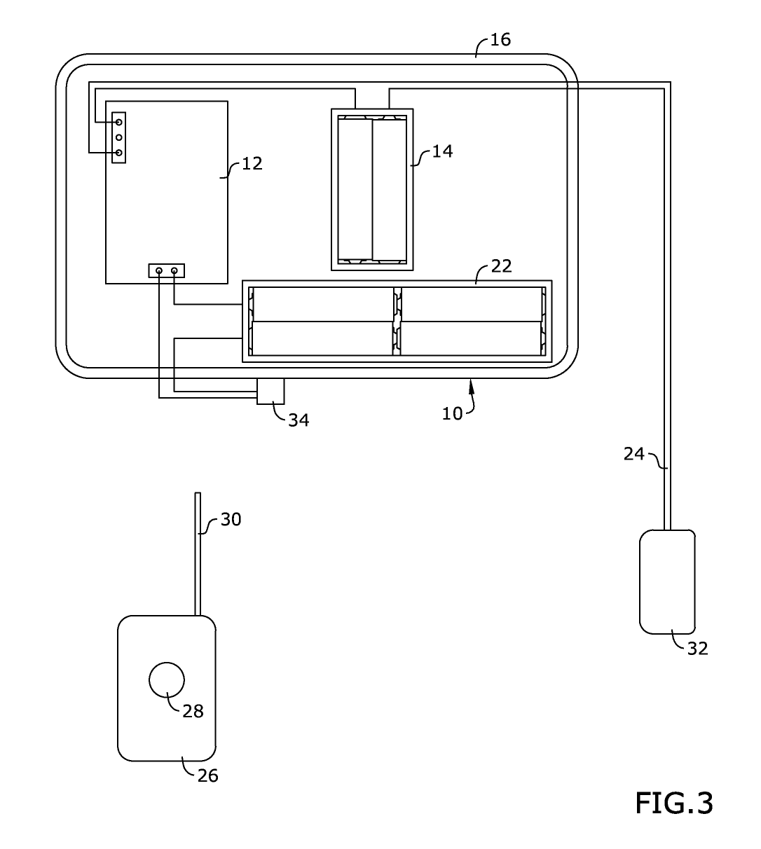

Referring to FIG. 1 through 4, the present invention includes a bird deterrent 10. The bird deterrent 10 includes a case 16, such as a water-resistant case 16. The case 16 includes an outer wall forming an internal housing to contain internal components of the bird deterrent 10. A wireless receiver 12 is secured within the internal housing of the case 16. The present invention further includes a power supply 14 to supply power to the vibration tip 32. The vibrating tip 32 is electrically connected to the power supply 14 and the wireless receiver 12 via electrical wiring 24. A remote transmitter 26 is operable to send a signal 40 to the wireless receiver 12. When the wireless receiver 12 receives the signal 40, the vibrating tip 32 produces a vibration.

The electrical wire 24 may include a first electrical wire connecting the power supply 14 to the vibrating tip 32, a second electrical wire connecting the vibrating tip 32 to the wireless receiver 12, and a third electrical wire connecting the power supply 14 and the wireless receiver 12. Therefore, when the remote transmitter 26 sends the signal 40, the second electrical wire and the third electrical wire may close the circuit from the power supply 14 to the vibrating tip 32, and thereby activating the vibrating tip 32.

As mentioned above, the present invention includes a remote transmitter 26. The remote transmitter 26 may include an antenna 30 to aid in the wireless transfer of the signal 40 to the wireless receiver 12. In certain embodiments, the remote transmitter 26 may include a button 28. The user 36 may press the button 28 to activate the transmission of the signal 40 from the antenna 30 to the wireless receiver 12.

The present invention may further include a switch 34 connected to the housing. The switch 34 may be electrically wired to a second power supply 22 for the wireless receiver 12. When placed in an on position, the switch 34 connects the second power supply 22 to the receiver 12 allowing electricity to flow to the receiver 12. When switch 34 is placed in an off position the power flow is stopped preventing the receiver 12 from draining the second power supply 22 when the unit is not in use. A fourth wire may connect the switch 34 to the second power supply 22, a fifth wire may connect the second power supply 22 to the wireless receiver 12, and a sixth wire may connect the switch 34 to the wireless receiver 12. In certain embodiments, the present invention may include a single power supply 22 and 14 combined. This single power supply 22 and 14 combined may be used to power the wireless receiver 12 and the vibration tip 32.

In certain embodiments, both the power supply 14 and the second power supply 22 may be secured within the case 16. The power supply 14, 22 may include batteries. In such embodiments, the case 16 may include a removable lid 18. Therefore, a user may remove the lid 18 to replace the batteries. In certain embodiments, the lid 18 may be secured to the case via screws 20. In certain embodiments the cover may be secured by clips.

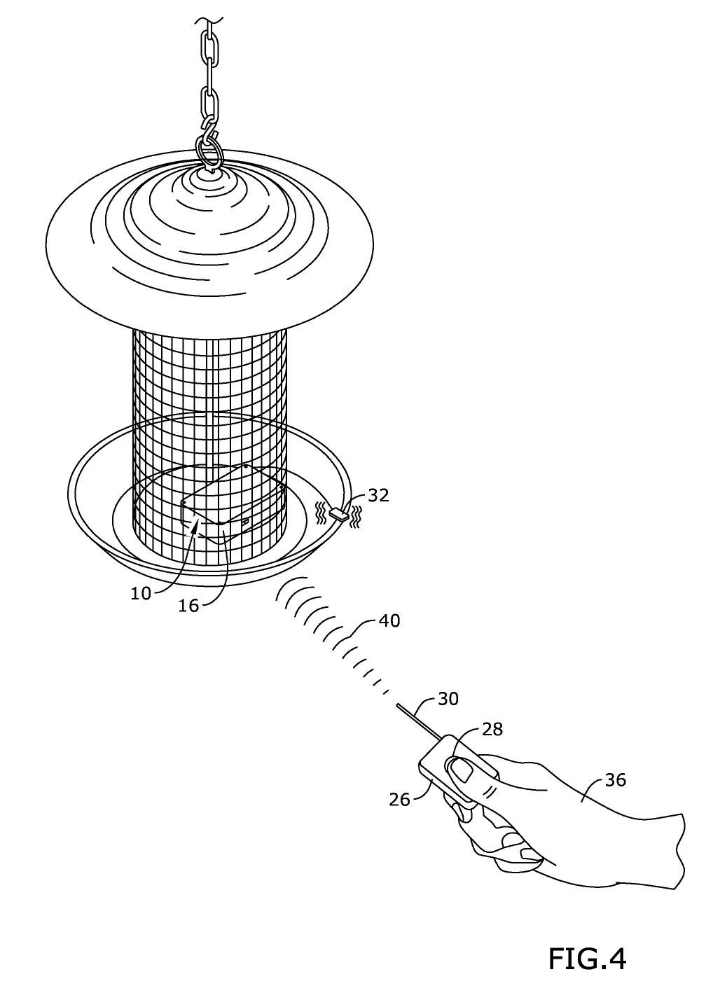

In certain embodiments, the vibrating tip 32 is located outside of the internal housing of the case 16. A portion of the electrical wiring 24 connected to the vibrating tip 32 is also located outside of the internal housing. Therefore, as illustrated in FIG. 4, the case 16 may be placed in one portion of the bird feeder, and the vibrating tip 32 may be placed in another portion of the bird feeder. For example, the vibration tip 32 may be dangling outside of the bird feeder where the bird sits. The user 36 sees an undesirable bird eating at the feeder. Upon activation by pressing the remote control transmitter 26, the vibration tip 32 begins to vibrate, making noise, motion, and vibration. Therefore, a quick press of the button 28 on the transmitter scares the undesirable bird away, then shuts off when the transmitter button 28 is released, allowing desirable birds to return.

It should be understood, of course, that the foregoing relates to exemplary embodiments of the invention and that modifications may be made without departing from the spirit and scope of the invention as set forth in the following claims.

What is claimed is:

1. A bird deterrent comprising:
a case comprising an outer wall forming an internal housing;
a wireless receiver within the internal housing of the case;
a power supply;
a vibrating tip electrically connected to the power supply and the wireless receiver via electrical wiring; and
a remote transmitter operable to send a signal to the wireless receiver, wherein when the wireless receiver receives the signal, the vibrating tip produces a vibration.

2. The bird deterrent of claim 1, where the electrical wiring comprises a first electrical wire connecting the power supply to the vibrating tip, a second electrical wire connecting the vibrating tip to the wireless receiver, and a third electrical wire connecting the power supply and the wireless receiver.

3. The bird deterrent of claim 1, wherein the power supply is within the internal housing.

4. The bird deterrent of claim 1, wherein the vibrating tip is outside of the internal housing.

5. The bird deterrent of claim 4, wherein a portion of the electrically wiring connected to the vibrating tip is outside of the internal housing.

6. The bird deterrent of claim 1, wherein the remote transmitter comprises a button operable to activate the sending of the signal from the remote transmitter to the wireless receiver.

7. The bird deterrent of claim 1, wherein the remote transmitter comprises an internal or external antenna.

8. The bird deterrent of claim 1, further comprising a switch connected to the housing and electrically wired to the wireless receiver, wherein when the switch is activated, power is supplied to the wireless receiver.

9. A bird deterrent comprising:
a case comprising an outer wall forming an internal housing;
a wireless receiver within the internal housing of the case;
a power supply;
a vibrating tip electrically connected to the power supply and the wireless receiver via electrical wiring, wherein the vibrating tip and a portion of the electrical wiring are outside of the housing; and
a remote transmitter operable to send a signal to the wireless receiver, wherein when the wireless receiver receives the signal, the vibrating tip produces a vibration.

10. The bird deterrent of claim 9, wherein the remote transmitter comprises a button operable to activate the sending of the signal from the remote transmitter to the wireless receiver.
